(19) United States
(12) Patent Application Publication
(10) Pub. No.: US 2013/0159086 A1
(43) Pub. Date: Jun. 20, 2013

(54) METHOD AND SYSTEM FOR PROVIDING LOCATION-BASED INCENTIVES AND PURCHASE OPPORTUNITIES TO REWARD PROGRAM MEMBERS

(71) Applicant: Postrel Richard, Miami Beach, FL (US)

(72) Inventor: Postrel Richard, Miami Beach, FL (US)

(21) Appl. No.: 13/325,739

(22) Filed: Dec. 14, 2011

(51) Int. Cl. G06Q 30/02; H04W 4/02

(52) U.S. Cl. 705/14.33; 705/14.27

(57) ABSTRACT

A method and system for generating and distributing incentives. An incentive server computer (ISC) receives a user identification from a mobile device that identifies an associated user. The ISC determines the location of the mobile device, and uses the user identification to determine one or more reward programs with which the user has a reward account. For each such reward program, the ISC determines if the location of the mobile device is within a predefined distance of a merchant affiliated with the reward program, and if so then generates a purchase incentive for the user to redeem at the merchant and transmits the purchase incentive to the mobile device. As a result, incentives are provided to those purchasers who are within a predefined proximity to the merchant, and who are more likely to use the incentive since they are already a member of an affiliated reward program.

### TECHNICAL FIELD

This invention relates to incentive systems, and in particular to a method and system for detecting when a user is at a certain location with respect to a merchant and providing a purchase incentive to that user based on his association with an affiliated reward program, as well as providing purchase opportunities to the user to enable him to purchase desired products at nearby merchants.

### BACKGROUND OF THE INVENTION

Incentive and reward systems are used by merchants to increase business interactions between the merchants and their customers. In one case, a merchant providing a purchase incentive such as a discount coupon will cause a purchaser to choose that merchant over others that sell the same or similar goods and services. Similarly, providing the purchaser with a reward, such as reward points, a discount coupon for subsequent purchases, a rebate in the form of cash back after purchase, etc., will cause the purchaser to choose that merchant over others that sell the same or similar goods and services. The cost of operating such incentive and reward programs is quite high with respect to the return on investment. Merchants are continually looking for ways to target incentives and rewards to appropriate customers; i.e. to those who are more likely to respond to the incentive by actually making a purchase with that merchant.

Consumers are often members of several such reward programs and have difficulties in managing their programs to obtain the optimal benefits from each program. One particular problem is that a consumer may wish to purchase a product from a merchant that does not offer a reward program, or the consumer may be a member of that merchant's reward program but not have enough reward points accrued that would enable the consumer to redeem his points in exchange for the desired product. Similarly, a consumer may have a reward account with an entity that does not offer any meaningful products for redemption of those points.

Therefore, merchants would like to target promotions to customers in order to drive more sales by providing purchase incentives in a targeted manner (i.e. to customers more likely to want to use that merchant) and also allow the customers to utilize reward points in an account with a different issuer, while reward points issuers are looking for ways to retire a consumers points in an advantageous manner, and consumers are looking to be able to obtain products in a convenient manner (i.e. from nearby merchants) and preferably utilize reward points from issuer programs that may not themselves offer a product desired by a consumer.

### SUMMARY OF THE INVENTION

Accordingly, in one aspect of the invention, provided is a computer-implemented method for generating and distributing purchase incentives to certain users (i.e. consumers or customers). A user who may be roaming in a given area carries a mobile device, which transmits a user identification that identifies that user. An incentive server computer receives the user identification from the mobile device, determines the location of the mobile device (for example, with GPS coordinate data from the mobile device), and uses the user identification to determine one or more reward programs with which the user has a reward account. For each reward program with which the user has a reward account, the incentive server computer determines at least one merchant that is affiliated with the reward program. For each such affiliated merchant, the incentive server computer determines if the location of the mobile device is within a predefined distance of the affiliated merchant. If the location of the mobile device is determined to be within a predefined distance of the affiliated merchant, then the incentive server computer generates a purchase incentive for the user to redeem at the affiliated merchant and transmits the purchase incentive to the mobile device. As a result, incentives are provided to those purchasers who are within a predefined proximity to a merchant who is affiliated with a reward program with which the user is already a member and thus more likely to use the incentive.

For example, the incentive server computer may be programmed to determine if the location of the mobile device is within a predefined distance of the affiliated merchant by comparing the location of the mobile device to a table of merchant location data. Also, the incentive server computer may use the user identification to determine one or more reward programs with which the user has a reward account by accessing a reward program database, the reward program database storing information indicating, for a plurality of users, which of a plurality of reward programs with which each of said plurality of users has a reward account.

In one embodiment, the value of the purchase incentive varies as a function of the distance between the mobile device (i.e. the user) and the merchant.

The merchant may for example be affiliated with a reward program when the reward program is administered by or on behalf of the merchant (i.e. the reward program is the merchant's own reward program). In addition, the merchant may be affiliated with a reward program when the reward program is not the merchant's own reward program, but when the merchant accepts reward points of another entity's reward program as consideration for the purchase of a product from the merchant.

The user may then execute a purchase transaction to purchase a product from the merchant by presenting the purchase incentive from the mobile device to the merchant; wherein the merchant may then apply the purchase incentive towards the purchase transaction. The merchant may then accept tender of reward points from an affiliated reward program with which the user has a reward account as reward consideration in at least partial payment for the purchase transaction. For example, the merchant accepts tender of reward points from an affiliated reward program with which the user has a reward account as reward consideration in at least partial payment for the purchase transaction by requesting a reward server on which the user reward account is stored to reduce the number of reward point by an amount corresponding to the reward consideration, wherein the reward server reduces the reward account by the requested amount of reward points, and the reward server conveys reward consideration to the merchant.

This methodology may be carried out by a system for generating and distributing incentives having a mobile device and an incentive server computer. The mobile device has a memory for storing a user identification identifying an associated user, and a wireless transceiver for transmitting the user identification and receiving a purchase incentive. The incentive server computer has a memory for storing a reward program database that stores records associating a user identification with one or more reward programs with which the user has a reward account. The incentive server computer is programmed to receive the user identification from a mobile device, determine the location of the mobile device, and access the reward program database with the user identification to determine one or more reward programs with which the user has a reward account. The incentive server computer is also programmed to, for each reward program with which the user has a reward account, determine a merchant that is affiliated with the reward program and determine if the location of the mobile device is within a predefined distance of the affiliated merchant. If the location of the mobile device determined to be within a predefined distance of the affiliated merchant, then the incentive server computer generates a purchase incentive for the user to redeem at the merchant and transmits the purchase incentive to the mobile device.

The mobile device may further include a GPS receiver that generates GPS coordinate data indicative of the location of the mobile device, in which case the wireless transceiver additionally transmits the mobile device GPS coordinate data to the incentive server computer and the incentive server computer is programmed to determine the location of the mobile device by using the mobile device GPS coordinate data.

The mobile device may be determined by the incentive server computer to be within a predefined distance of the affiliated merchant by comparing the location of the mobile device to a table of merchant location data.

In a second aspect of the invention, provided is a computer-implemented method for a user finding a merchant that sells a product desired by the user. A mobile device transmits to an incentive server computer a data message that includes location data indicative of the location of the mobile device and a user identification identifying a user associated with the mobile device. The incentive server computer uses the user identification to determine one or more reward programs with which the user has a reward account. The user enters a description of a desired product on the mobile device, and the mobile device transmits the description of the desired product to the incentive server computer. The incentive server computer determines at least one affiliated merchant that (i) sells the desired product, (ii) is within a predefined distance of the location of the mobile device, and (iii) is affiliated with a reward program with which the user has a reward account. The incentive server computer transmits an identification of the at least one affiliated merchant to the mobile device, which displays the identification of the at least one affiliated merchant received from the incentive server computer. The mobile device displays on a map view and/or on a list view the identification of the at least one affiliated merchant received from the incentive server computer.

Optionally, the incentive server computer may determine at least one non-affiliated merchant that (i) sells the desired product, (ii) is within a predefined distance of the location of the mobile device, and (iii) is not affiliated with a reward program with which the user has a reward account. In this case, the incentive server computer transmits an identification of the at least one non-affiliated merchant to the mobile device, and the mobile device displays the identification of the at least one non-affiliated merchant received from the incentive server computer. Preferably, the identification of the at least one affiliated merchant and identification of the at least one non-affiliated merchant are displayed with visually distinct icons.

In another embodiment of this aspect of the invention, the steps of entering a description of a desired product on the mobile device, transmitting the description of the desired product to the incentive server computer, and determining at least one affiliated merchant that (i) sells the desired product, (ii) is within a predefined distance of the location of the mobile device, and (iii) is affiliated with a reward program with which the user has a reward account, are repeated for a plurality of desired products. In this case, the incentive server computer determines an ordered list of merchants with routing instructions that provide an optimal route between all of the merchants, and the mobile device displays the ordered list of merchants on a map view and/or a list view.

### BRIEF DESCRIPTION OF THE DRAWING

FIG. 1 is a block diagram of the system of the present invention.

FIG. 2 is a flowchart of the operation of the present invention.

FIG. 3 is a detailed block diagram of the mobile device used in the present invention.

FIG. 4 is a flowchart of an embodiment of the invention in which distance is a factor used to determine a incentive pushed to the mobile user.

FIG. 5 illustrates various location zones used in the embodiment of FIG. 4.

FIG. 6 is a screen shot of a mobile device display that provides for product searching in a given area.

FIG. 7 is a screen shot in which a group of desired products is listed for the user.

FIGS. 8 and 9 are flowcharts of the product search embodiment.

### DESCRIPTION OF THE PREFERRED EMBODIMENTS

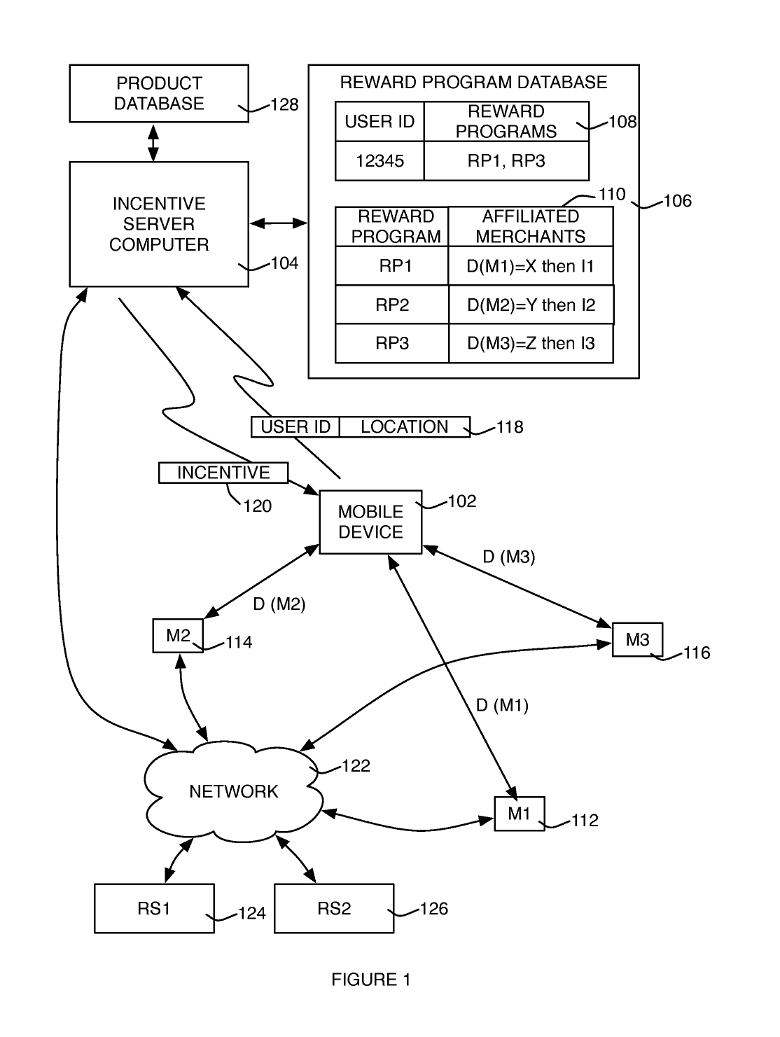

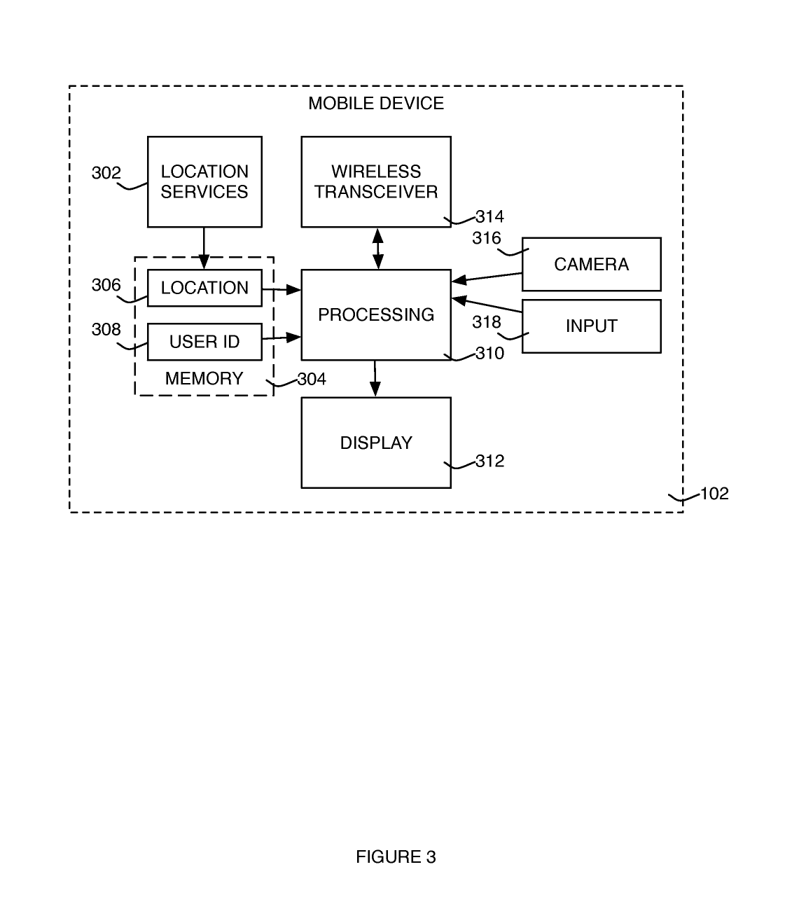

The present invention will now be discussed in detail with respect to the Figures. FIG. 1 illustrates a basic block diagram of the preferred embodiment of the first aspect of the present invention, in which purchase incentives are delivered to a mobile device of a user based on several factors as will be discussed below. Shown in FIG. 1 is a mobile device 102 that is carried by a user (not shown). The mobile device 102 may be any type of mobile device capable of carrying out the functions that are described herein, the major functions of which are wireless communications, data input, processing, memory and display. Typical examples of mobile devices 102 include but are not limited to a smartphone such as an IPHONE device, ANDROID device, or BLACKBERRY device, a tablet such as an IPAD, a laptop computer, and the like. Preferably the mobile device will also have GPS capabilities, which will aid in enabling the location services described herein. However, GPS capabilities are not necessary since location services may be attained in other ways such as cell phone triangulation, wi-fi hotspots, etc. The mobile device 102 is shown in further detail in FIG. 3 and explained further herein.

Also shown in FIG. 1 is an incentive server computer 104, which may for example be any type of general purpose computer such as a server computer executing software to carry out the functions of the present invention as will be described. The incentive server computer may operate on any applicable platform such as WINDOWS, MAC OS, LINUX, etc. The incentive server computer will also have associated communications means that will enable it to communicate with the mobile device such as via a wired and/or wireless network as well known in the art. Also, the incentive server communicates with and various merchant computers M1 112, M2 114 and M3 116 and reward server computers RS1 124 and RS2 126, such as via a computer network 122 such as but not limited to the Internet.

A reward program database 106 is stored on or in association with the incentive server computer 104, and includes a table 108 that stores records that link each registered user, via his or her user ID, to one or more reward programs with which the user has registered and has a reward account. For example, as shown in FIG. 1, the user with user ID 12345 (typically assigned by the incentive server computer during an initial registration process) is registered in a reward program RP1, and also is registered in a reward program RP3. For example, RP1 may AMERICAN EXPRESS MEMBERSHIP REWARDS. Of course, many more reward programs may be part of this system, including credit card issuer reward programs, retail store reward programs, frequent flyer programs (wherein miles are equivalent to reward points), etc. This database table may be assembled for example by having each user indicate on a web page form which reward programs he is a member of, which is submitted to the incentive server computer for inclusion in the table 108.

The database 106 also has a linked merchant location table 110 having records for each registered reward program, which indicate one or more affiliated merchants as well as the incentive parameters that have been established for that reward program that determine how incentives may be distributed in this system.

A merchant is considered to be affiliated with a reward program when the reward program is administered by or on behalf of the merchant (i.e. the reward program is the merchant's own reward program). In addition, the merchant may be affiliated with a reward program when the reward program is not the merchant's own reward program, but when when the merchant accepts reward points of (another entity's) reward program as consideration for the purchase of a product from the merchant. For example, the merchant ACME ELECTRONICS may administer its own reward program ACME ELECTRONICS REWARDS, wherein it provides reward points when a user makes purchases at any ACME ELECTRONICS store and allows the user to redeem the ACME ELECTRONICS reward points for products from its stores as known in the art. In addition, ACME ELECTRONICS may be affiliated with the AMERICAN EXPRESS MEMBERSHIP REWARDS reward program if it allows its customers to utilize their AMERICAN EXPRESS MEMBERSHIP REWARD points when making a purchase at an ACME ELECTRONICS store. This may be accomplished in this system by the user making payment by having the merchant ACM ELECTRONICS merchant the reward program MEMBERSHIP REWARDS to reduce the number of points in the user's MEMBERSHIP REWARDS account by a certain amount, and then MEMBERSHIP REWARDS would convey consideration equivalent to those reduced points to the merchant ACME ELECTRONICS in full or partial payment for the item being purchased by the user. Thus, by the merchant and reward program being affiliated through a pre-existing contractual relationship, the user is able to use reward points from one of his reward programs to pay for products from an affiliated merchant that will interoperate with that affiliated reward program for payment. The example given herein is illustrative and non-limiting; other affiliations may exist between a merchant and a reward program that would function in the present invention.

The parameters shown in table 110 indicate the conditions that must be met in order for an incentive to be distributed to a user based on the requirements of the reward program and/or affiliated merchant. For example, for RP1 (AMERICAN EXPRESS MEMBERSHIP REWARDS), if a registered AMERICAN EXPRESS MEMBERSHIP REWARDS user is within a distance X of affiliated merchant M1 (ACME ELECTRONICS), then incentive I1 will be delivered to the mobile device 102 of that user. Similarly, for RP2, if a registered user is within a distance Y of M2, then incentive I2 will be delivered to the mobile device 102 of that user, and for RP3 if a registered user is within a distance Z of M3, then incentive I3 will be delivered to the mobile device 102 of that user. These are teaching examples of how the distance based algorithms may be implemented and may provide various levels of granularity as will be described further herein.

With reference to FIG. 3, the mobile device 102 has a memory 304 for storing a user identification 308 identifying an associated user as well as location data 306. The location data 306 may be provided by location services 302, which typically would be a GPS receiver that functions to provide GPS coordinate data (latitude, longitude) of the mobile device 102 as well known in the art. Other types of location services may also be used instead of GPS, such as cell phone triangulation. A cell phone's location may be triangulated by communicating with several cell phone towers whose location is know, and then calculating an approximate location of the cell phone mobile device for use as location data 306. In the alternative, location services may be attained based on wi-fi hotspot location data, where the mobile device communicates via wi-fi with hot spots whose location is known, in a manner similar to cell phone tower triangulation. All of these location service techniques and methodologies are well known in the art and need not be further described herein.

The mobile device 102 also has a wireless transceiver 314 for transmitting the user identification 308 and location data 306 in data message 118 and receiving a purchase incentive 120 as shown in FIG. 1. Of course the wireless transceiver may perform other communications functions as well, such as when the mobile device 102 is a smartphone such as an IPHONE. Also shown in FIG. 3 is processing circuitry 310 for controlling the functionality of the mobile device as described herein, and an input device(s) 318 for enabling the user to input data, select functions, etc. as well known in the art. The input device(s) may be hard buttons such as pushbuttons that are dedicated or programmable to select certain functions of the mobile device. Also shown is a display 312 for displaying the incentive 120 as will be described further herein. As known in the art, the display 312 may be a touch screen display that incorporates input functionality as well. A camera 316 may also be provided that would enable to user to capture an image for input purposes (e.g. such as imaging a UPC bar code for product identification) as described in further detail below.

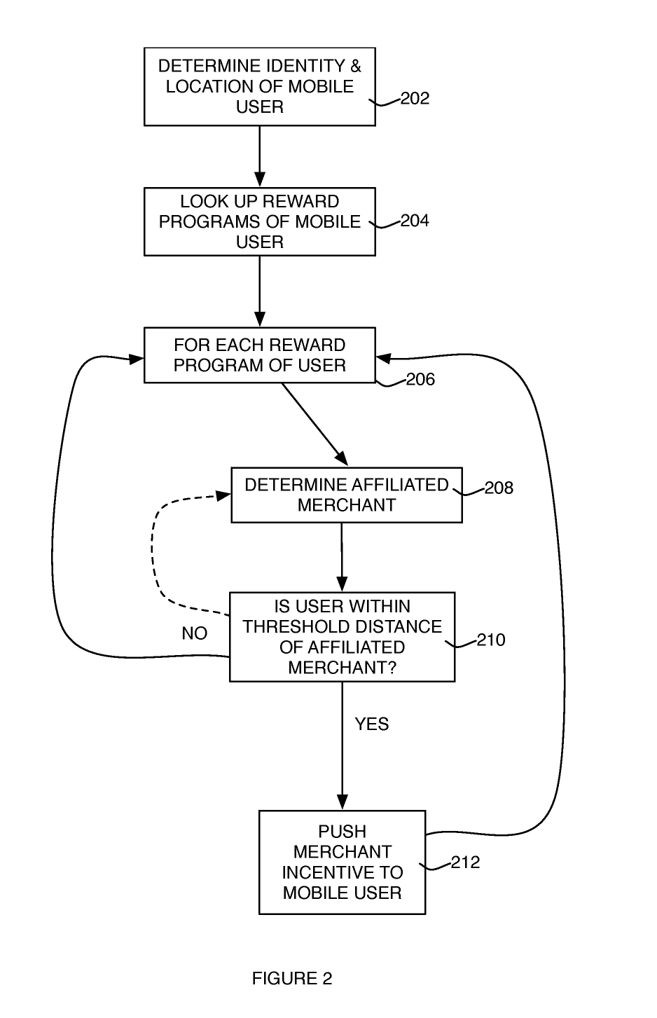

FIG. 2 illustrates a basic flowchart of the operation of the preferred embodiment for generating and distributing incentives. The mobile device 102 periodically determines its location via location services 302 and generates a data message 118 which includes its location data 306 and the associated user ID 308. Data message 118 may be transmitted periodically, such as every minute, every 10 minutes, etc., or it may be transmitted on demand of the user by enabling the user to press a button on the (touch screen) display 312, or it may be transmitted on request by the incentive server computer 104. This functionality would be controlled by an application executing on the mobile device 102 and configured via a settings or preference panel as desired. The incentive server computer 104 receives the user identification 308 and location data 306 from the mobile device 102 via a wireless network communication interface. For example, the data communications between the incentive server computer 104 and the mobile device 102 may occur via a wireless (cellular) data network and Internet connection as known in the art. At step 202, the incentive server computer 104 determines the location of the mobile device 102, and uses the user identification 308 at step 204 to determine one or more reward programs with which the user has a reward account. This is accomplished by using the user ID to access the table 108 in the reward program database 106 as shown in FIG. 1. In this example, user 12345 has already registered with a reward programs RP1 and RP3.

At the next step 206, an analysis is done for each reward program with which the user has a reward account with reference to table 108. First, the incentive server computer 104 determines at step 208 an affiliated merchant with reference to table 110. This information may be previously provided by the reward programs and/or the affiliated merchants. Next, at step 210, the incentive server computer 104 determines if the location 306 of the mobile device 102 is within a predefined distance of the affiliated merchant as stated in the rule shown for RP1 in table 110. If the rule is satisfied, then at step 212 an incentive I1 is pushed to the user's mobile device. This may be repeated for more than one affiliated merchant as shown by the dotted repeat line in FIG. 2. When no more affiliated merchants have been considered for a given reward program, then the process reiterates for the next reward program for which the user is registered.

So, in this case, the user 12345 has been determined to be a member of reward programs RP1 and RP3. As indicated in merchant table 110, RP1 specifies that any registered user that is within a distance X from affiliated merchant M1 should have an incentive I1 delivered to his mobile device 102. Similarly, as indicated in merchant location table 110, RP3 specifies that any registered user that is within a distance Z from merchant M3 should have an incentive I3 delivered to his mobile device 102. Table 110 also indicates that RP2 specifies that any registered user that is within a distance Y from affiliated merchant M2 should have an incentive I2 delivered to his mobile device 102, but since user 12345 is not a member of program RP2 (as indicated in table 108), he will not receive incentive I2. Thus, at step 210, user 12345 will have incentive I1 delivered to his mobile device when it is determined by the incentive server computer 104 that the mobile device 102 is within a distance X from merchant M1, and he will also have incentive I3 delivered to his mobile device when it is determined by the incentive server computer 104 that the mobile device 102 is within a distance Z from merchant M1. This is done on an iterative basis as shown by the loop in the flowchart of FIG. 2.

The user may then execute a purchase transaction to purchase a product from the merchant by presenting the purchase incentive from the mobile device to the merchant; wherein the merchant may then apply the purchase incentive towards the purchase transaction. In one embodiment, the purchase incentive is simply displayed on the display screen 312 of the mobile device 102, and the merchant would then apply the purchase incentive after viewing it. The incentive may simply state “JOHN SMITH WILL RECEIVE 20% OFF THE PURCHASE OF A NEW SONY 55-INCH 3D LED TELEVISION” or something similar in nature. Alternatively, a bar code may be generated so that the incentive information is encoded in the bar code, scanned with a scanner at the point of sale terminal, and then automatically applied to the purchase in the same manner as prior art paper coupons.

In one embodiment, the merchant may accept tender of reward points from an affiliated reward program with which the user has a reward account as reward consideration in at least partial payment for the purchase transaction. For example, the merchant may request a reward server on which the user reward account is stored to reduce the number of reward points by an amount corresponding to the reward consideration, wherein the reward server reduces the reward account by the requested amount of reward points, and the reward server conveys reward consideration to the merchant. As an example with reference to FIG. 1, merchant M1 may accept reward points that are being stored at reward server RS1 on behalf of user 12345 in order to pay at least partially for the purchase transaction. In this example, user 12345 offers to use 10,000 reward points stored at RS1. Merchant M1 sends a redemption request to RS1, stating that 10,000 points held for user 12345 should be redeemed. Reward server RS1 will then reduce the reward account of user 12345 by 10,000 points and convey consideration to merchant M1 in an equivalent amount, which may be $100 if each reward point is redeemed at the value of one penny per point. This will reduce the purchase amount by $100. In an alternative embodiment, the merchant M1 may also allow user 12345 to redeem points from multiple rewards servers in the same process, and apply all the consideration received towards the purchase price of the product.

As a result, incentives are provided to those purchasers who are within a predefined proximity to a certain merchant, and who are more likely to use the incentive since they are already a member of an affiliated reward program.

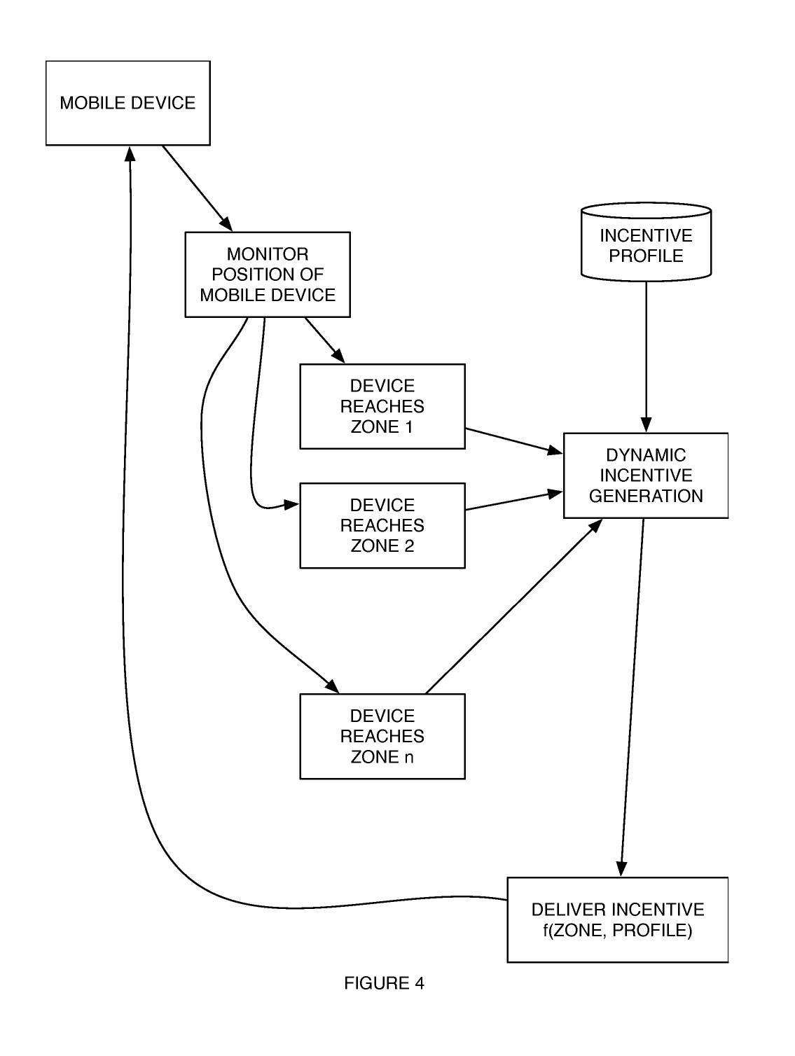

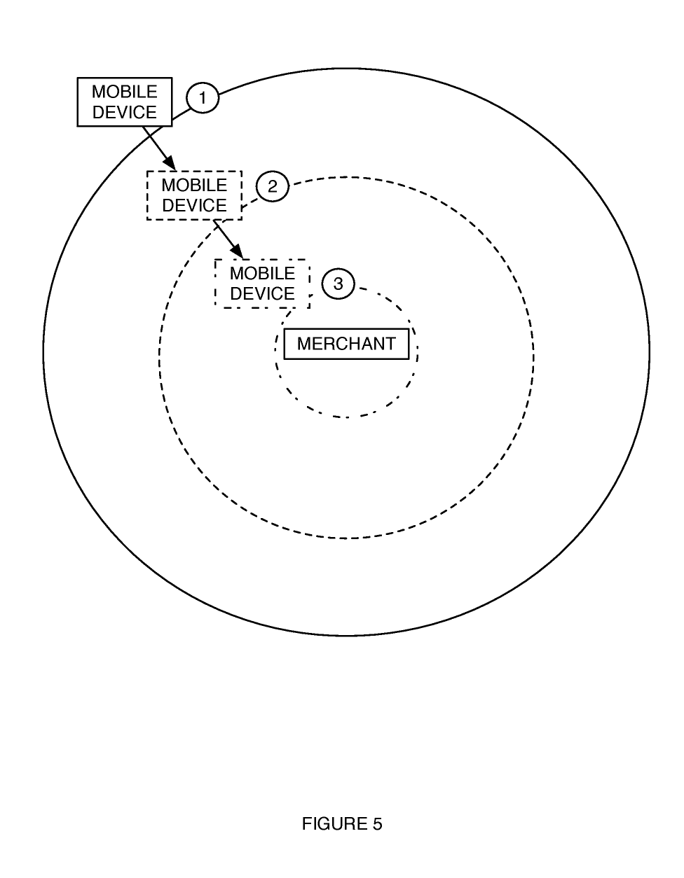

In an alternative embodiment, the value of the purchase incentive varies as a function of the distance between the mobile device and the merchant. Referring to FIG. 4 and FIG. 5, the location of the mobile device 102 is monitored as previously described. In this embodiment, however, different zones 1,2 and 3 with respect to the merchant are established as shown in FIG. 5. As the mobile device 102 enters zone 1 it may receive a first type of incentive, as it enters zone 2 it may receive a second type of incentive, and as it enters zone 3 it may receive a third type of incentive. The types of incentives may vary in accordance with the zone, and/or the amount provided on the incentives may vary as well. So as shown in FIG. 4, when the mobile device reaches zone 1 an incentive will be dynamically generated in accordance with an incentive profile that may be a modified version of table 110 in FIG. 1. Then, when the mobile device reaches zone 2 an incentive will be dynamically generated in accordance with the incentive profile, etc. These incentives are delivered to the mobile device and redeemed as previously described.

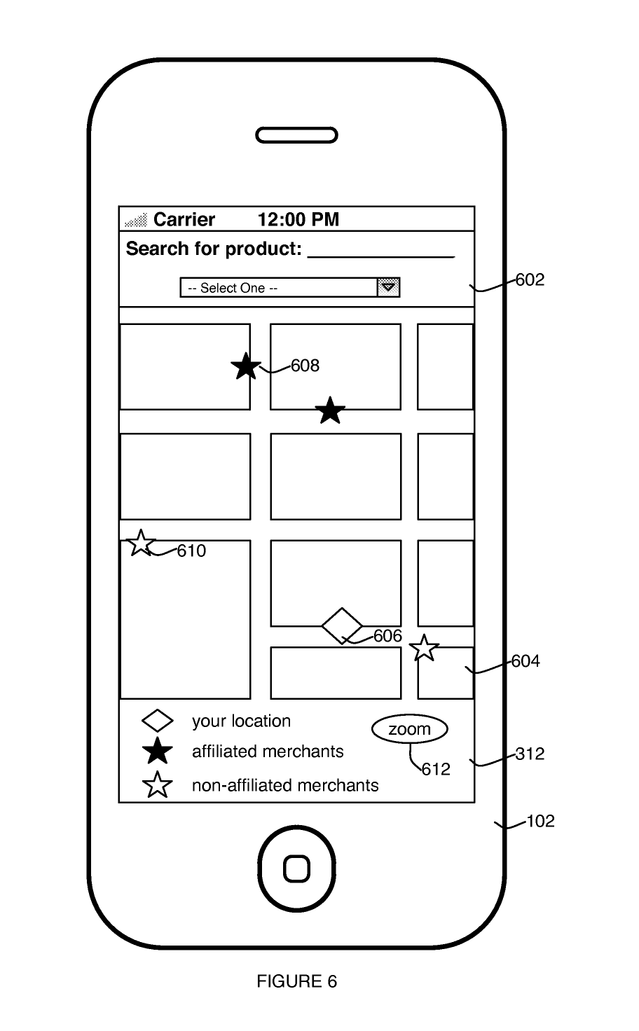

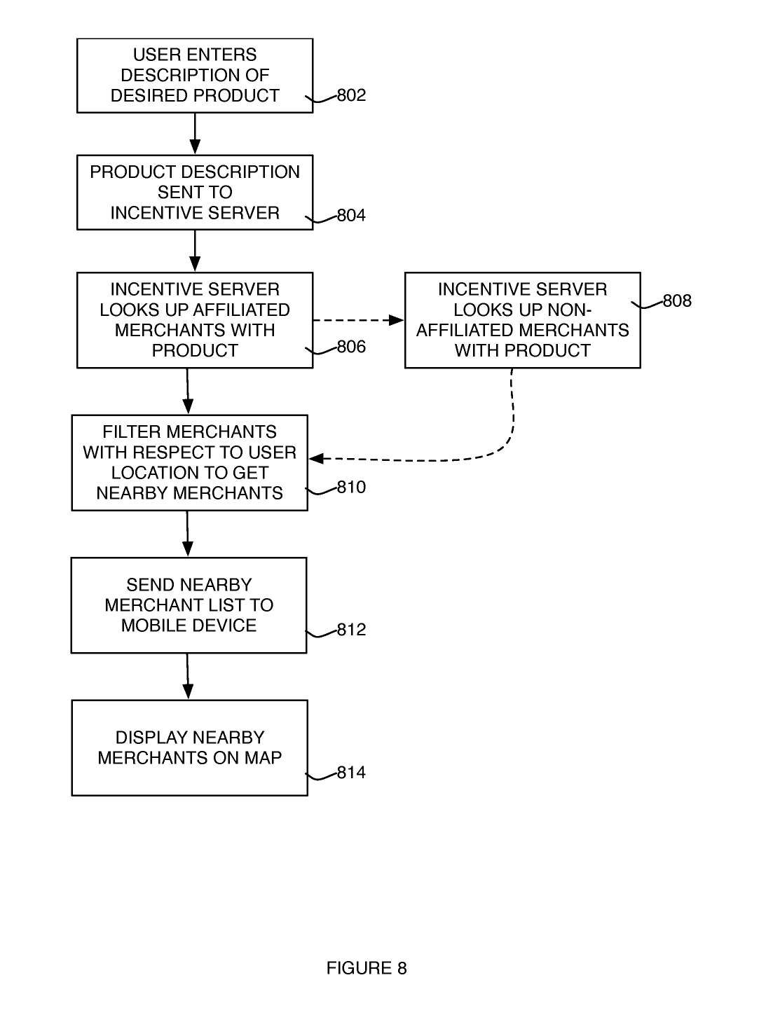

In another aspect, this system provides the ability for the user to designate a product (goods or services) in which the user has an interest in purchasing. For example, the user may operate a software application on the mobile device 102 that provides a user interface as shown in FIG. 6. Further reference is made to the flowchart of FIG. 8. On the display 312 of the mobile device 102, a product search entry section 602 is provided, that will enable a user to enter a description of a desired product by one or more mechanisms well known in the art, such as a drop down list, text entry box, etc. In the alternative, the user may utilize automated data entry such as by imaging a bar code symbol (e.g. UPC symbol on an existing product, brochure, newspaper ad, etc.) with the camera 316, wherein the scanned bar code data is decoded and used to lookup a product description from a UPC table as well known in the art. After the user has entered a desired product at step 802, one or more icons are displayed on a map 604 of the area in which the user is presently located. Location icon 606 shows the user's current location on the map 604, which may be zoomed in or out by using zoom button 612. Also shown on the map 604 will be one or more affiliated merchant icons 608 and/or non-affiliated merchant icons 610 that offer for sale the product that has been entered by the user in product search entry section 602. In the example shown a black star designates affiliated merchants and a white star designates non-affiliated merchants, but any graphical scheme may be used such as different colors and the like.

By viewing the map 604, the user can easily ascertain the locations of various merchants that are near his current location and obtain directions to any of the merchants if desired. The name and/or other identifying indicia may be displayed alongside the icon for each merchant. By selecting an icon of a desired merchant, the user can ascertain more information of the merchant such as name, address, telephone number, store hours, type of affiliation (if any), and the like. By zooming out with button 612, more merchants may be displayed on the map.

The incentive server computer 104 (or an associated computer) is able to generate the map display of FIG. 6 by referring to a product database 128 as shown in FIG. 1. The product database will be populated with information as to the products that are offered by each of the affiliated merchants M1 112, M2 114, M3 116 etc. Additionally, products that are offered by non-affiliated merchants are also referenced in the product database 128. Thus, when the user enters at step 802 a desired product into the product search entry section 602, for example an IPOD, then that product entry is sent back to the incentive server computer 104 at step 804 for searching on the product database 128. The incentive server computer 104 will search for affiliated merchants at step 806 that carry the desired product, and optionally may search for non-affiliated merchants at step 808. The determination of affiliated merchants is discussed above with reference to tables 108 and 110. If a merchant is not listed as being affiliated with a reward program with which the user has a reward account, then that merchant is considered to be a non-affiliated merchant. The incentive server 128 will then have a list of affiliated merchants and (optionally) non-affiliated merchants who offer an IPOD for sale. The geographical location of each merchant is filtered against the location of the user at step 810, and a list of nearby merchants is provided to the mobile device at step 812 for display on the map 604 at step 814 as described above.

The user may then select an icon of interest to get more information on a particular merchant as described above. For example, the user may look at the map and see that one merchant is closer than another, and then select that merchant to get more information. In the alternative or addition to the map, a list of merchants may be provided in textual format, sorted and/or grouped as desired such as in order of proximity to the location of the user.

The user may opt to travel to the merchant of interest and execute a purchase transaction at that merchant for the desired product. Optionally, the user may have an incentive delivered to his mobile device as described above, which may be used to redeem for the desired product. Further optionally, the user may execute an online transaction with a desired merchant for the selected product.

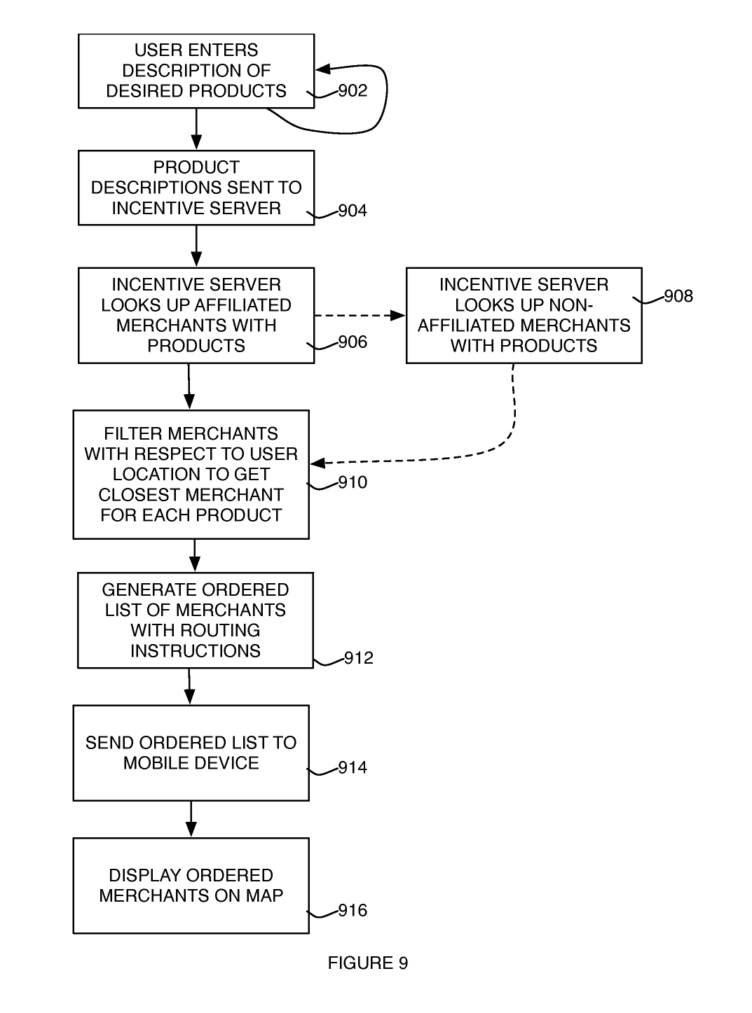

In an alternative embodiment shown by the flowchart of FIG. 9, the product entry functionality may be used as follows. A user may enter one or more desired products at step 902, similar to providing a shopping list, using the entry techniques described above. For example, a user may be in traveling to a location where many merchants are located and would like assistance in finding and purchasing various products. He may enter several items such as IPOD, DVD player, HALO XBOX game, as well as services such as Chinese food (where he may want to have lunch). These product entries are used by the incentive server computer to determine various merchants that may have the items desired.

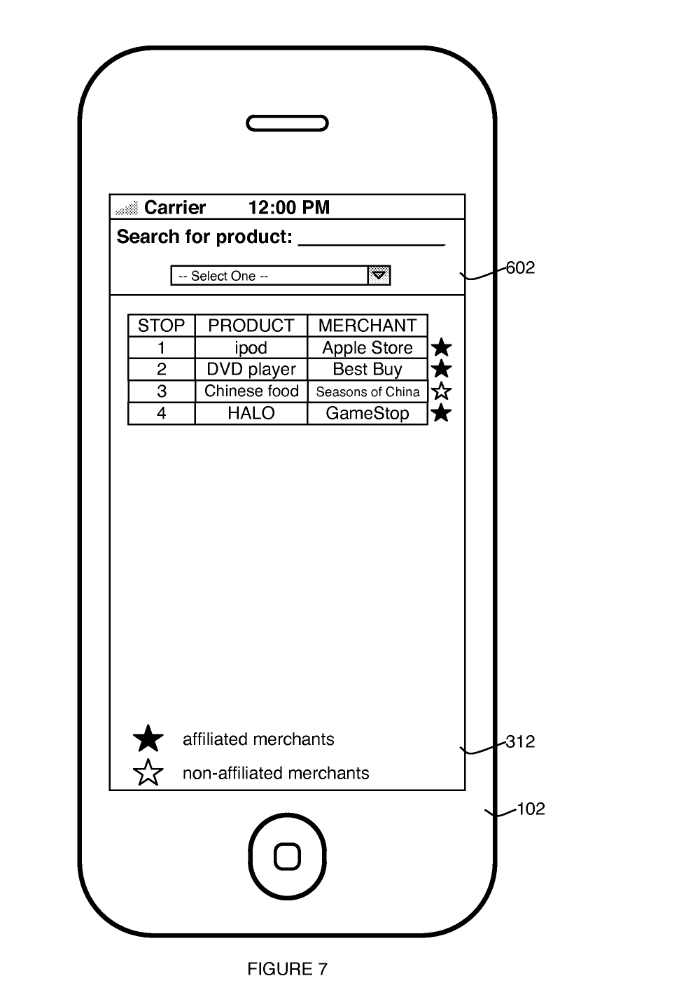

By analyzing the locations of the merchants that carry the desired products, as well as the location of the user, the incentive server computer may determine a suggested shopping trip for the user. For example, the incentive server computer may determine that certain merchants are close to each other and collectively carry all of the desired products. Optionally, this group of merchants may be filtered by specifying only those merchants who are affiliated with the user's reward programs as described above. Thus, at step 904 the product entries are sent back to the incentive server computer 104 at step 904 for searching on the product database 128. The incentive server computer 104 will search for affiliated merchants at step 906 that carry the desired product, and optionally may search for non-affiliated merchants at step 908. The incentive server 128 will then have a list of affiliated merchants and (optionally) non-affiliated merchants who offer the desired products for sale. The geographical location of each merchant is filtered against the location of the user at step 910 to get the merchant who is closest to the user location. An ordered list of merchants is generated at step 912, along with routing instructions to enable the user to travel from one merchant to the next one. The incentive server computer sends the ordered list to the mobile device at step 914, and the mobile device may at step 916 present the results of this analysis to the user on a map as shown in FIG. 6, and/or may provide an ordered list of merchants that the user may visit to purchase the desired products. The map and/or list may provide routing instructions (either walking or by car) that will help the user accomplish his shopping in an efficient manner. An example of an ordered list display is shown in FIG. 7.

Further information may be provided for each merchant by selecting the merchant of interest. As each merchant is visited, that merchant be removed from the list or grayed out to designate completion of that stop. Also, if desired, a merchant may be selected and a substitute request made if the user would like to see different merchants on the list. In that case the incentive server computer would access the product database and select a different merchant that meets the requirements of the purchase.

Incentives may be delivered to the mobile device as well, so the user can see which merchants are providing discounts and the like.

Thus, by utilizing the system and methods of the present invention, a user is able to obtain purchase incentives for use with merchants within a predetermined proximity which are affiliated with a reward program with which he is a member, such that the user is able to use the incentive to visit the merchant and purchase a product using, if desired, reward points in order to make partial or full payment utilizing the reward points of the affiliated reward program. Additionally, the user is able to specify a desired product such that the system will provide the user with a list of affiliated (or optionally non-affiliated) merchants within proximity of the user that carry that product for sale.

What is claimed is:

1. A computer-implemented method for generating and distributing incentives comprising:
a. a mobile device transmitting to an incentive server computer a data message comprising location data indicative of the location of the mobile device and a user identification identifying a user associated with the mobile device;
b. the incentive server computer using the user identification to determine one or more reward programs with which the user has a reward account;
c. for each reward program with which the user has a reward account,
(i) the incentive server computer determining a merchant that is affiliated with the reward program;
(ii) the incentive server computer determining if the location of the mobile device is within a predefined distance of the affiliated merchant; and
(ii) if the location of the mobile device is determined to be within a predefined distance of the affiliated merchant, then the incentive server computer generating a purchase incentive for the user to redeem at the affiliated merchant and transmitting the purchase incentive to the mobile device; and
d. the mobile device receiving the purchase incentive from the incentive server computer.

2. The method of claim 1 wherein the location data comprises mobile device GPS coordinate data of the mobile device.

3. The method of claim 1 wherein the incentive server computer is programmed to determine if the location of the mobile device is within a predefined distance of the affiliated merchant by comparing the location of the mobile device to a table of merchant location data.

4. The method of claim 1 wherein the step of the incentive server computer using the user identification to determine one or more reward programs with which the user has a reward account comprises the incentive server computer accessing a reward program database, the reward program database comprising information indicating, for a plurality of users, which of a plurality of reward programs with which each of said plurality of users has a reward account.

5. The method of claim 1 wherein the value of the purchase incentive varies as a function of the distance between the mobile device and the affiliated merchant.

6. The method of claim 1 wherein the purchase incentive is a discount coupon that provides a discount to the user for purchase of an item associated with the purchase incentive.

7. The method of claim 1 wherein the purchase incentive is a rebate coupon that provides a rebate to the user after purchase of an item associated with the purchase incentive.

8. The method of claim 1 wherein the purchase incentive is a reward points coupon that provides reward points to the user after purchase of an item associated with the purchase incentive.

9. The method of claim 1 wherein the merchant is affiliated with a reward program when the merchant accepts reward points of the reward program as consideration for the purchase of a product from the merchant.

10. The method of claim 9 further comprising executing a purchase transaction by:
e. the user executing a purchase transaction to purchase a product from the affiliated merchant;
f. the user presenting the purchase incentive from the mobile device to a merchant point of sale terminal at the affiliated merchant;
g. the merchant point of sale terminal applying the purchase incentive towards the purchase transaction;
h. the merchant point of sale terminal accepting tender of reward points from an affiliated reward program with which the user has a reward account as reward consideration in at least partial payment for the purchase transaction.

11. The method of claim 10 wherein the step of the merchant point of sale terminal accepting tender of reward points from an affiliated reward program with which the user has a reward account as reward consideration in at least partial payment for the purchase transaction comprises
i. the merchant point of sale terminal requesting a reward server on which the user reward account is stored to reduce the number of reward point by an amount corresponding to the reward consideration;
ii. the reward server reducing the reward account by the requested amount of reward points; and
iii. the reward server conveying reward consideration to the merchant point of sale terminal.

12. A system for generating and distributing incentives comprising:
A. a mobile device comprising:
a. a memory for storing a user identification identifying an associated user, and
b. a wireless transceiver for transmitting the user identification and receiving a purchase incentive; and
B. an incentive server computer comprising a memory for storing a reward program database that stores records associating a user identification with one or more reward programs with which the user has a reward account, the incentive server computer programmed to:
a. receive the user identification from a mobile device,
b. determine the location of the mobile device,
c. access the reward program database with the user identification to determine one or more reward programs with which the user has a reward account, and
d. for each reward program with which the user has a reward account,
(i) determine a merchant that is affiliated with the reward program;
(ii) determine if the location of the mobile device is within a predefined distance of the affiliated merchant; and
(iii) if the location of the mobile device is determined to be within a predefined distance of the affiliated merchant, then generate a purchase incentive for the user to redeem at the merchant and transmit the purchase incentive to the mobile device.

13. The system of claim 12 wherein
the mobile device further comprises a GPS receiver that generates GPS coordinate data indicative of the location of the mobile device, and wherein the wireless transceiver additionally transmits the mobile device GPS coordinate data to the incentive server computer; and
the incentive server computer is programmed to determine the location of the mobile device by using the mobile device GPS coordinate data.

14. The system of claim 12 wherein the mobile device is determined by the incentive server computer to be within a predefined distance of the affiliated merchant by comparing the location of the mobile device to a table of merchant location data.

15. The system of claim 12 wherein the value of the purchase incentive varies as a function of the distance between the mobile device and the affiliated merchant.

16. The system of claim 12 wherein the merchant is affiliated with a reward program when the merchant accepts reward points of the reward program as consideration for the purchase of a product from the merchant.

17. The system of claim 12 wherein the purchase incentive is a discount coupon that provides a discount to the user for purchase of an item associated with the purchase incentive.

18. The system of claim 12 wherein the purchase incentive is a rebate coupon that provides a rebate to the user after purchase of an item associated with the purchase incentive.

19. The system of claim 12 wherein the purchase incentive is a reward points coupon that provides reward points to the user after purchase of an item associated with the purchase incentive.

20. The system of claim 12 further comprising a merchant point of sale terminal comprising an input device for inputting the purchase incentive during a purchase transaction for purchase of an item associated with the purchase incentive, the merchant point of sale terminal programmed to apply the purchase incentive to the purchase transaction.

21. The system of claim 20 wherein the input device of the merchant point of sale terminal comprises a bar code scanner, and wherein the purchase incentive is encoded into a bar code that is readable by the bar code scanner.

22. The system of claim 20 wherein the merchant point of sale terminal is further programmed to execute the purchase transaction utilizing reward consideration comprising reward points as at least partial consideration towards the purchase transaction.

23. The system of claim 21 wherein the merchant point of sale terminal is further programmed to request a reward server on which a user reward account is stored to reduce the number of reward points in the user reward account by an amount corresponding to the reward consideration and to convey the reward consideration to the merchant.

24. A computer-implemented method for an incentive server computer generating and distributing incentives comprising:
a. an incentive server computer receiving a user identification from a mobile device, the user identification identifying a user associated with the mobile device;
b. the incentive server computer determining the location of the mobile device;
c. the incentive server computer using the user identification to determine one or more reward programs with which the user has a reward account;
d. for each reward program with which the user has a reward account,
(i) the incentive server computer determining a merchant that is affiliated with the reward program;
(ii) the incentive server computer determining if the location of the mobile device is within a predefined distance of the affiliated merchant; and
(iii) if the location of the mobile device is determined to be within a predefined distance of the affiliated merchant, then the incentive server computer generating a purchase incentive for the user to redeem at the affiliated merchant and transmitting the purchase incentive to the mobile device.

25. The method of claim 24 wherein the step of the incentive server computer determining the location of the mobile device comprises the incentive server computer receiving mobile device GPS coordinate data from the mobile device.

26. The method of claim 24 wherein the incentive server computer is programmed to determine if the location of the mobile device is within a predefined distance of the affiliated merchant by comparing the location of the mobile device to a table of merchant location data.

27. The method of claim 24 wherein the step of the incentive server computer using the user identification to determine one or more reward programs with which the user has a reward account comprises the incentive server computer accessing a reward program database, the reward program database comprising information indicating, for a plurality of users, which of a plurality of reward programs with which each of said plurality of users has a reward account.

28. The method of claim 24 wherein the value of the purchase incentive varies as a function of the distance between the mobile device and the affiliated merchant.

29. The method of claim 24 wherein the merchant is affiliated with a reward program when the merchant accepts reward points of the reward program as consideration for the purchase of a product from the merchant.

30. The method of claim 24 wherein the purchase incentive is a discount coupon that provides a discount to the user for purchase of an item associated with the purchase incentive.

31. The method of claim 24 wherein the purchase incentive is a rebate coupon that provides a rebate to the user after purchase of an item associated with the purchase incentive.

32. The method of claim 24 wherein the purchase incentive is a reward points coupon that provides reward points to the user after purchase of an item associated with the purchase incentive.

33. An incentive server computer for generating and distributing incentives comprising a memory for storing a reward program database that stores records associating a user identification with one or more reward programs with which the user has a reward account, the incentive server computer programmed to:
a. receive from a mobile device a user identification identifying an associated user,
b. determine the location of the mobile device,
c. access the reward program database with the user identification to determine one or more reward programs with which the user has a reward account, and
d. for each reward program with which the user has a reward account,
(i) determine a merchant that is affiliated with the reward program;
(ii) determine if the location of the mobile device is within a predefined distance of the affiliated merchant; and
(ii) if the location of the mobile device is determined to be within a predefined distance of the affiliated merchant, then the generate a purchase incentive for the user to redeem at the merchant and transmit the purchase incentive to the mobile device.

34. The incentive server computer of claim 33 programmed to determine the location of the mobile device by using mobile device GPS coordinate data received from the mobile device.

35. The incentive server computer of claim 33 wherein the mobile device is determined by the incentive server computer to be within a predefined distance of the affiliated merchant by comparing the location of the mobile device to a table of merchant location data.

36. The incentive server computer of claim 33 wherein the value of the purchase incentive varies as a function of the distance between the mobile device and the affiliated merchant.

37. The incentive server computer of claim 33 wherein the merchant is affiliated with a reward program when the merchant accepts reward points of the reward program as consideration for the purchase of a product from the merchant.

38. The incentive server computer of claim 33 wherein the purchase incentive is a discount coupon that provides a discount to the user for purchase of an item associated with the purchase incentive.

39. The incentive server computer of claim 33 wherein the purchase incentive is a rebate coupon that provides a rebate to the user after purchase of an item associated with the purchase incentive.

40. The incentive server computer of claim 33 wherein the purchase incentive is a reward points coupon that provides reward points to the user after purchase of an item associated with the purchase incentive.

41. A computer-implemented method for implementing incentives comprising:
a. a mobile device transmitting to an incentive server computer a data message comprising location data indicative of the location of the mobile device and a user identification identifying a user associated with the mobile device;
b. the mobile device receiving from the incentive server computer a purchase incentive generated by the incentive server computer by using the user identification to determine one or more reward programs with which the user has a reward account; and for each reward program with which the user has a reward account, then determining if the location of the mobile device is within a predefined distance of a merchant affiliated with the reward program; and if the location of the mobile device is determined to be within a predefined distance of a merchant affiliated with the reward program, then the incentive server computer generating the purchase incentive for the user to redeem at the merchant.

42. The method of claim 41 wherein the location data comprises mobile device GPS coordinate data of the mobile device.

43. The method of claim 41 wherein the value of the purchase incentive varies as a function of the distance between the mobile device and the merchant.

44. The method of claim 41 wherein the purchase incentive is a discount coupon that provides a discount to the user for purchase of an item associated with the purchase incentive.

45. The method of claim 41 wherein the purchase incentive is a rebate coupon that provides a rebate to the user after purchase of an item associated with the purchase incentive.

46. The method of claim 41 wherein the purchase incentive is a reward points coupon that provides reward points to the user after purchase of an item associated with the purchase incentive.

47. The method of claim 41 wherein the merchant is affiliated with a reward program when the merchant accepts reward points of the reward program as consideration for the purchase of a product from the merchant.

48. The method of claim 41 further comprising executing a purchase transaction by:
a. the user executing a purchase transaction to purchase a product from the merchant;
b. the user presenting the purchase incentive from the mobile device to a merchant point of sale terminal to enable the merchant point of sale terminal to apply the purchase incentive towards the purchase transaction and accept tender of reward points from an affiliated reward program with which the user has a reward account as reward consideration in at least partial payment for the purchase transaction.

49. A mobile device comprising:
a. a memory for storing a user identification identifying an associated user,
b. a GPS receiver that generates location data comprising GPS coordinate data indicative of the location of the mobile device,
c. a wireless transceiver for transmitting to an incentive server computer a data message comprising the location data and the user identification, and for receiving a purchase incentive generated by the incentive server computer by using the user identification to determine one or more reward programs with which the user has a reward account; and for each reward program with which the user has a reward account, then determining if the location of the mobile device is within a predefined distance of a merchant affiliated with the reward program; and if the location of the mobile device is determined to be within a predefined distance of a merchant affiliated with the reward program, then the incentive server computer generating the purchase incentive for the user to redeem at the merchant.

50. The mobile device of claim 49 wherein the value of the purchase incentive varies as a function of the distance between the mobile device and the merchant.

51. The mobile device of claim 49 wherein the purchase incentive is a discount coupon that provides a discount to the user for purchase of an item associated with the purchase incentive.

52. The mobile device of claim 49 wherein the purchase incentive is a rebate coupon that provides a rebate to the user after purchase of an item associated with the purchase incentive.

53. The mobile device of claim 49 wherein the purchase incentive is a reward points coupon that provides reward points to the user after purchase of an item associated with the purchase incentive.

54. The mobile device of claim 49 wherein the merchant is affiliated with a reward program when the merchant accepts reward points of the reward program as consideration for the purchase of a product from the merchant.

55. The mobile device of claim 49 programmed to encode a bar code comprising the purchase incentive.

56. A computer-implemented method for finding a merchant that sells a desired product comprising:
a. a mobile device transmitting to an incentive server computer a data message comprising location data indicative of the location of the mobile device and a user identification identifying a user associated with the mobile device;
b. the incentive server computer using the user identification to determine one or more reward programs with which the user has a reward account;
c. the user entering a description of a desired product on the mobile device;
d. the mobile device transmitting the description of the desired product to the incentive server computer;
e. the incentive server computer determining at least one merchant that (i) sells the desired product, (ii) is within a predefined distance of the location of the mobile device, and (iii) is affiliated with a reward program with which the user has a reward account;
f. the incentive server computer transmitting an identification of the at least one affiliated merchant to the mobile device; and
g. the mobile device displaying the identification of the at least one affiliated merchant received from the incentive server computer.

57. The method of claim 56 wherein the mobile device displays on a map view the identification of the at least one affiliated merchant received from the incentive server computer.

58. The method of claim 56 wherein the mobile device displays on a list view the identification of the at least one affiliated merchant received from the incentive server computer.

59. The method of claim 56 comprising the further steps of
h. the incentive server computer determining at least one non-affiliated merchant that (i) sells the desired product, (ii) is within a predefined distance of the location of the mobile device, and (iii) is not affiliated with a reward program with which the user has a reward account;
i. the incentive server computer transmitting an identification of the at least one non-affiliated merchant to the mobile device; and
j. the mobile device displaying the identification of the at least one non-affiliated merchant received from the incentive server computer.

60. The method of claim 59 wherein the identification of the at least one affiliated merchant and identification of the at least one non-affiliated merchant are displayed with visually distinct icons.

61. The method of claim 56 wherein steps c, d and e are repeated for a plurality of desired products, and wherein the incentive server computer determines an ordered list of merchants with routing instructions that provide an optimal route between all of the merchants, and wherein the mobile device displays the ordered list of merchants.

62. The method of claim 56 wherein the mobile device displays on a map view the identification of the at least one affiliated merchant received from the incentive server computer.

63. The method of claim 56 wherein the mobile device displays on a list view the identification of the at least one affiliated merchant received from the incentive server computer.
